(19) United States
(12) Patent Application Publication
(10) Pub. No.: US 2014/0181653 A1
(43) Pub. Date: Jun. 26, 2014

(54) CONTENT PRESENTATION WITH ENHANCED USER EXPERIENCE

(71) Applicant: Johannes P. Schmidt, Los Altos Hills, CA (US)

(72) Inventor: Johannes P. Schmidt, Los Altos Hills, CA (US)

(21) Appl. No.: 13/727,138

(22) Filed: Dec. 26, 2012

(51) Int. Cl. G06F 3/048

(52) U.S. Cl. CPC G06F 3/048
USPC 715/716

(57) ABSTRACT

Apparatuses, methods and storage medium associated with content consumption are disclosed herein. In embodiments, an apparatus may include a decoder, a user interface engine, and a presentation engine. The decoder may be configured to receive and decode a streaming of the content. The user interface engine may be configured to receive user commands. The presentation engine may be configured to present the content as the content is decoded from the stream, in response to received user commands. Further, the decoder, the user interface engine, the presentation engine, and/or combination/sub-combination thereof, may be arranged to adapt the presentation to enhance user experience during response to a first of the user commands, where the adaption is in addition to a nominal response to the first user command. Other embodiments may be described and/or claimed.

### TECHNICAL FIELD

The present disclosure relates to the field of data processing, in particular, to apparatuses, methods and storage medium associated with content presentation.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Advances in computing, networking and related technologies have led to proliferation in the availability of multi-media contents, and the manners the contents are consumed. Today, multi-media contents may be available from fixed medium (e.g., Digital Versatile Disk (DVD)), broadcast, cable operators, satellite channels, Internet, and so forth. User may consume contents with a television set, a laptop or desktop computer, a tablet, a smartphone, or other devices of the like. In addition to the contents themselves, ease of consumption remains an important factor to the overall user experience and satisfaction.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an arrangement for content distribution and consumption, in accordance with various embodiments.

FIG. 2 illustrates a content stream in further detail, in accordance with various embodiments.

FIG. 3 illustrates an example process for presenting content, in accordance with various embodiments.

FIG. 4 illustrates an example computing environment suitable for practicing the disclosure, in accordance with various embodiments.

FIG. 5 illustrates an example storage medium with instructions configured to enable an apparatus to practice the present disclosure, in accordance with various embodiments.

### DETAILED DESCRIPTION

Apparatuses, methods and storage medium associated with content distribution and/or consumption are disclosed herein. In embodiments, an apparatus, e.g., a set-top box, may include a decoder, a user interface engine, and a presentation engine. The decoder may be configured to receive and decode a streaming of a content, e.g., an audio/video program. The user interface engine may be configured to receive user commands, e.g., a pause command, a fast forward command, and so forth. The presentation engine may be configured to present the content as the content is decoded and recovered from the stream, in response to received user commands. Further, the decoder, the user interface engine, the presentation engine, and/or combination/sub-combination thereof, may be arranged to adapt the presentation to enhance user experience, e.g., enhanced resolution, during response to a user command, where the adaptation is in addition to a nominal response to the user command.

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “module” may refer to, be part of, or include an Application Specific Integrated Circuit (“ASIC”), an electronic circuit, a processor (shared, dedicated, or group) and/or memory (shared, dedicated, or group) that execute one or more software or firmware programs, a combinational logic circuit, and/or other suitable components that provide the described functionality.

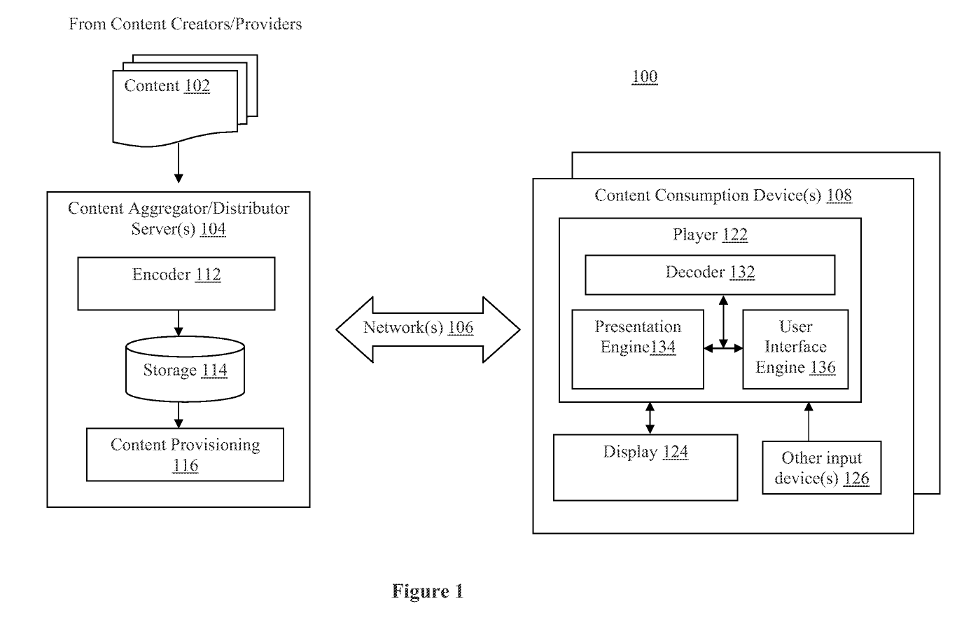

Referring now FIG. 1, wherein an arrangement for content distribution and consumption, in accordance with various embodiments, is illustrated. As shown, in embodiments, arrangement 100 for distribution and consumption of content may include a number of content consumption devices 108 coupled with one or more content aggregation/distribution servers 104 via one or more networks 106. Content aggregation/distribution servers 104 may be configured to aggregate and distribute contents to content consumption devices 108 for consumption, via one or more networks 106. As will be described in more detail below, content aggregation/distribution servers 104 and/or content consumption devices 108 may be incorporated with various teachings of the present disclosure to provide users of content consumption devices 108 with potentially enhanced user experience.

In embodiments, as shown, content aggregation/distribution servers 104 may include encoder 112, storage 114 and content provisioning 116, coupled to each other as shown. Encoder 112 may be configured to encode contents 102 from various content providers, and storage 114 may be configured to store encoded content. Content provisioning 116 may be configured to selectively retrieve and stream encoded content to the various content consumption devices 108 in response to requests from the various content consumption devices 108.

Contents 102 may be multi-media contents of various types, having video, audio, and/or closed captions, from a variety of content creators and/or providers. Examples of contents may include, but are not limited to, movies, TV programming, user created contents (such as YouTube video, iReporter video), music albums/titles/pieces, and so forth. Examples of content creators and/or providers may include, but are not limited to, movie studios/distributors, television programmers, television broadcasters, satellite programming broadcasters, cable operators, online users, and so forth.

In embodiments, for efficiency of operation, encoder 112 may be configured to transcode the various contents 102, typically in different encoding formats, into a subset of one or more common encoding formats. However, encoder 112 may be configured to nonetheless maintain indices or cross-references to the corresponding contents in their original encoding formats. Similarly, for flexibility of operation, encoder 112 may transcode or otherwise process each or selected ones of contents 102 into multiple versions of different quality levels. The different versions may provide different resolutions, and/or require different bit rates and/or frame rates for transmission and/or playing. In various embodiments, the encoder 112 may publish, or otherwise make available, information on the available different resolutions, different bitrates, and/or different frame rates. For example, the encoder 112 may publish bitrates at which it may provide video or audio content to the content consumption device(s) 108. Encoding of audio data may be performed in accordance with, e.g., but are not limited to, the MP3 standard, promulgated by the Moving Picture Experts Group (MPEG). Encoding of video and/or audio data may be performed in accordance with, e.g., but are not limited to, the H264 standard, promulgated by the International Telecommunication Unit (ITU) Video Coding Experts Group (VCEG). Encoder 112 may include one or more computing devices configured to perform content portioning, encoding, and/or transcoding, such as described herein.

Storage 114 may be temporal and/or persistent storage of any type, including, but are not limited to, volatile and non-volatile memory, optical, magnetic and/or solid state mass storage, and so forth. Volatile memory may include, but are not limited to, static and/or dynamic random access memory. Non-volatile memory may include, but are not limited to, electrically erasable programmable read-only memory, phase change memory, resistive memory, and so forth.

Content provisioning 116 may, in various embodiments, be configured to provide encoded content as discrete files and/or as continuous streams of encoded content. Content provisioning 116 may be configured to transmit the compressed audio/video data (and closed captions, if provided) in accordance with any one of a number of streaming and/or transmission protocols. The streaming protocols may include, but are not limited to, the Real-Time Streaming Protocol (RTSP). Transmission protocols may include, but are not limited to, the transmission control protocol (TCP), user datagram protocol (UDP), and so forth.

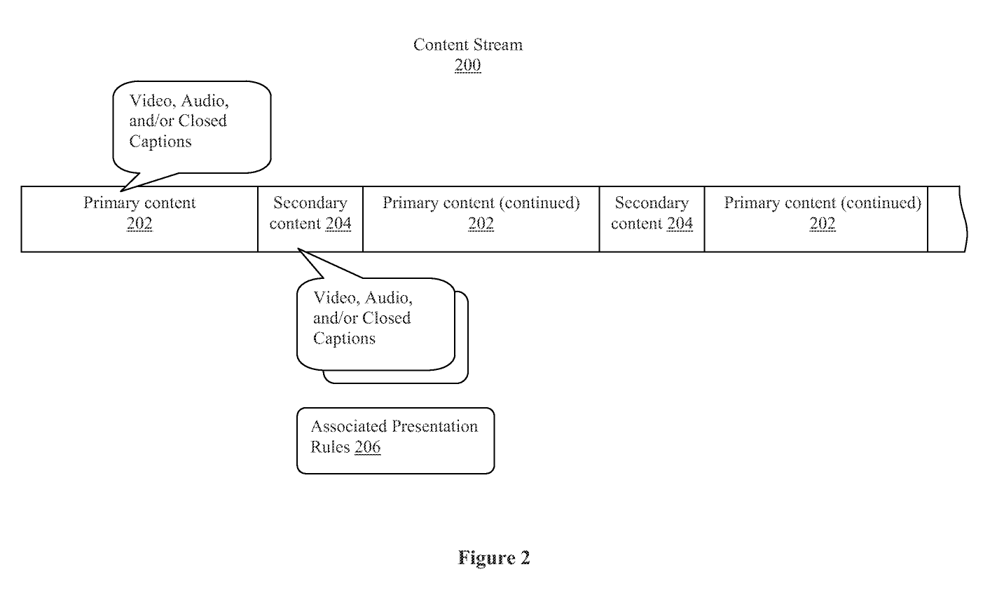

Additionally, in embodiments, content provisioning 116 may be further configured to insert other contents, e.g., advertisements or commercials, into a content stream. Referring now also to FIG. 2, wherein an example content stream, in accordance with various embodiments, is illustrated. As shown, in embodiments, a content stream include primary and secondary contents 202 and 204. Primary content 202, e.g., a television program, may be divided into multiple segments, and secondary contents 204, e.g., commercials, may be interleaved with the primary content segments 204. A set of one or more secondary contents 204 may be inserted between two primary content segments 202. Further, secondary contents 204 may have associated presentation rules 206. In embodiments, content provisioning 116 may be further configured to embed associated presentation rules 206 in content stream 200. In embodiments, associated presentations rules 206 may be embedded as part of the meta data of content stream 200.

Referring back to FIG. 1, networks 106 may be any combinations of private and/or public, wired and/or wireless, local and/or wide area networks. Private networks may include, e.g., but are not limited to, enterprise networks. Public networks, may include, e.g., but is not limited to the Internet. Wired networks, may include, e.g., but are not limited to, Ethernet networks. Wireless networks, may include, e.g., but are not limited to, Wi-Fi, or 3G/4G networks. It would be appreciated that at the content distribution end, networks 106 may include one or more local area networks with gateways and firewalls, through which servers 104 go through to communicate with content consumption devices 108. Similarly, at the content consumption end, networks 106 may include base stations and/or access points, through which consumption devices 108 communicate with servers 104. In between the two ends may be any number of network routers, switches and other networking equipment of the like. However, for ease of understanding, these gateways, firewalls, routers, switches, base stations, access points and the like are not shown.

In embodiments, as shown, a content consumption device 108 may include player 122, display 124 and user input device 126. Player 122 may be configured to receive streamed content, decode and recovered the content from the content stream, and present the recovered content on display 124, in response to user selections/inputs from user input device 126. Further, player 122 may be configured to adapt the presentation of a content to enhance user experience during response to some user commands, where the adaptation is in addition to a nominal response to the user commands. Similarly, for enhancing user experience, player 122 may be configured to partially respond to one or more other user commands in view of one or more rules associated with presentation of the content.

In embodiments, player 122 may include decoder 132, presentation engine 134 and user interface engine 136. Decoder 132 may be configured to receive streamed content, decode and recover the content from the content stream. Presentation engine 134 may be configured to present the recovered content on display 124, in response to user selections/inputs. User interface engine 136 may be configured to receive the user selections/inputs from a user.

Further, in various embodiments, decoder 132, presentation engine 136, and user engine 136, combinations or sub-combinations thereof, may be configured to effectuate for player 122 the earlier described adaptation of the presentation of a content to enhance user experience during response to some user commands, where the adaptation is in addition to a nominal response to the user commands. Similarly, decoder 132, presentation engine 136, and user engine 136, combinations or sub-combinations thereof, may also be configured to effectuate for player 122 the earlier described partial response to one or more other user commands in view of one or more rules associated with presentation of the content to enhance user experience.

While shown as part of a content consumption device 108, display 124 and/or user input device(s) 126 may be standalone devices or integrated, for different embodiments of content consumption devices 108. For example, for a television arrangement, display 124 may be a stand atone television set, Liquid Crystal Display (LCD), Plasma and the like, while player 122 may be part of a separate set-top set, and other user input device 126 may be a separate remote control or keyboard. Similarly, for a desktop computer arrangement, player 122, display 124 and other input device(s) 126 may all be separate stand atone units. On the other hand, for a tablet arrangement, display 124 may be a touch sensitive display screen that includes other user input device(s) 126, and player 122 may be a computing platform with a soft keyboard that also include one of the user input device(s) 126. Further, display 124 and player 122 may be integrated within a single form factor. Similarly, for a smartphone arrangement, player 122, display 124 and other input device(s) 126 may be likewise integrated.

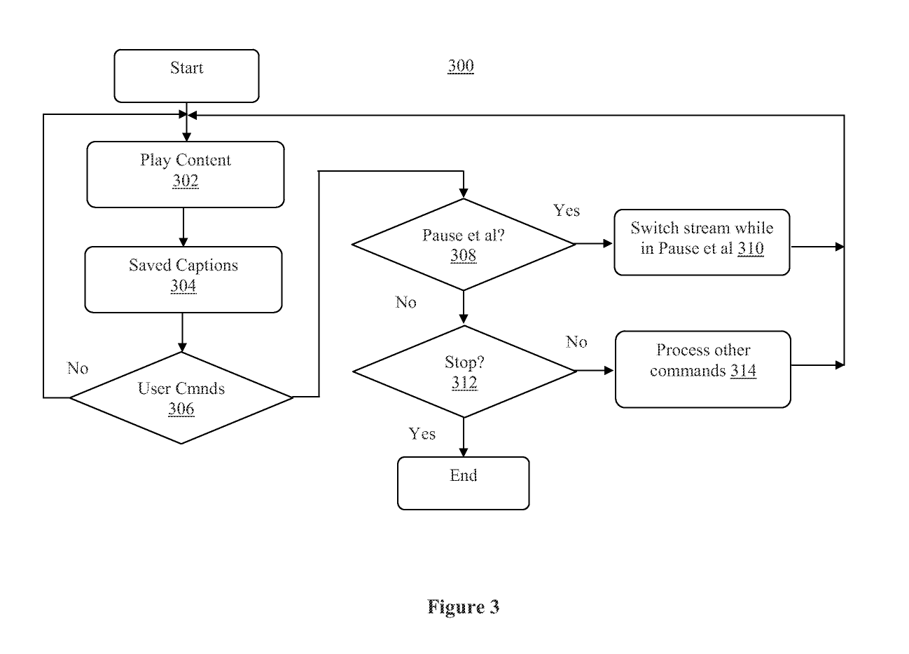

Referring now to FIG. 3, wherein an example process for presenting content, in accordance with various embodiments, is illustrated. As shown, process 300 may start at block 302, where content may be played. As described earlier, content playing may include presentation of content (primary and secondary, if included) recovered from a received content stream, e.g., by presentation engine 134, onto a display device, e.g., display 124. From block 302, the process may proceed to block 304. In block 304, an amount of the closed captions associated with the content being played may be cached, e.g., by presentation engine 134. The closed captions may be cached regardless whether the recovered content is being played with or without closed caption enabled. From block 304, process 300 may proceed to block 306. At block 306, process 300 may determine, e.g., by user interface engine 136, whether a user command has been received.

If a result of the determination at block 306 indicates that no user command has been received, process 300 may return to block 302, and continue from there as earlier described. On the other hand, if a result of the determination at block 306 indicates a user command has been received, process 300 may proceed to block 308. At block 308, process 300 may determine, e.g., by user interface engine 136, whether the received user command is one of a pause, a slow motion, a fast forward or a rewind command.

If a result of the determination at block 308 indicates that the received user command is one of a pause, a slow motion, a fast forward or a rewind command, process 300 may proceed to block 310. At block 310, process 300 may pause, slow down, fast forward or rewind the playing of content as commanded, e.g., by presentation engine 134 on notification by user interface engine 136. Additionally, in responding to one of these commands, process 300 may perform one or more operations to enhance user experience, where the operations are in addition to a nominal response to the user command.

In embodiments, in the case of a pause command, process 300 at block 310 may cause a higher resolution version of the paused frame to be presented, thereby potentially enhancing the user's experience. For example, on pausing the presentation of content, presentation engine 134 may request decoder 132 to retrieve, decode, and provide a higher resolution version of the paused frame. In response, decoder 132 may retrieve from content aggregation/distribution server 104 the higher resolution version of the paused frame, decode and provide the higher resolution version of the paused frame accordingly.

In the case of a stow motion command, process 300 at block 310 may similarly cause the presentation of content to be based from a higher resolution, higher bit rate and/or higher frame rate version of the content stream instead, thereby potentially enhancing the user's experience. For example, on starting to slow presentation of the content, presentation engine 134 may request decoder 132 to switch to retrieve, decode, and provide a higher resolution, higher bit-rate and/or higher frame rate version of the content stream. In response, decoder 132 may request content aggregation/distribution server 104 to provide the higher resolution, higher bit-rate and/or higher frame rate version of the content stream, decode and provide the higher quality content accordingly.

In the case of a fast forward or rewind command, process 300 may similarly cause the presentation of content to be based from a higher resolution and/or higher bit rate version of the content stream instead, thereby potentially increasing the user's experience. For example, on starting to fast forward or rewind presentation of the content, presentation engine 134 may request decoder 132 to switch to retrieve, decode, and provide a higher resolution and/or higher bit-rate version of the content stream. In response, decoder 132 may request content aggregation/distribution server 104 to provide the higher resolution and/or higher bit-rate version of the content stream, decode and provide the higher quality content accordingly.

Alternatively, in the case of a fast forward or rewind command, process 300 may cause the presentation of content to be based from a lower bit rate version of the content stream instead, thereby potentially enhancing the user's experience. For example, on starting to fast forward or rewind presentation of the content, presentation engine 134 may request decoder 132 to switch to retrieve, decode, and provide a slower bit-rate version of the content stream. In response, decoder 132 may request content aggregation/distribution server 104 to provide the lower bit-rate version of the content stream, decode and provide the lower quality content accordingly.

Some users may consider the additional higher resolution, higher bit rate and/or higher frame response to the fast forward or rewind command as enhanced experience, while others may consider the lower bit rate response as enhanced experience. Thus, in embodiments, the additional response in the case of fast forward or rewind command may be configurable/selectable.

Before proceeding with further disclosure, it should be noted that while the additional response to provide enhance user experience in the case of fast forward or rewind command has been described as configurable/selectable, in embodiments, some or each of the additional response to provide potentially enhanced user experience may be configurable/selectable.

Still referring to FIG. 3, from block 310, process 300 may return to block 302 and from there continue as earlier described.

Referring again to block 308, if a result of the determination indicates that the received user command is not one of a pause, slow motion, fast forward or rewind command, process 300 may proceed to block 312. At block 312, process 300 may determine whether the received user command is a stop command. If a result of the determination at block 312 indicates that the received user command is nota stop command, process 300 may proceed to block 314, where the command may be processed accordingly.

From block 314, process 300 may return to block 302 and from there continue as earlier described.

On the other hand, if a result of the determination at block 312 indicates that the received command is a stop command, process 300 may end.

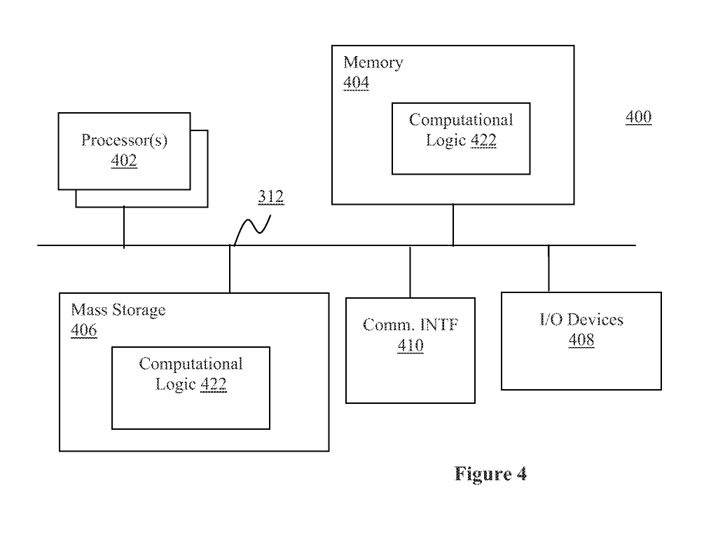

Referring now to FIG. 4, wherein an example computer suitable for use for the arrangement of FIG. 1, in accordance with various embodiments, is illustrated. As shown, computer 400 may include one or more processors or processor cores 402, and system memory 404. For the purpose of this application, including the claims, the terms “processor” and “processor cores” may be considered synonymous, unless the context clearly requires otherwise. Additionally, computer 400 may include mass storage devices 406 (such as diskette, hard drive, compact disc read only memory (CD-ROM) and so forth), input/output devices 408 (such as display, keyboard, cursor control and so forth) and communication interfaces 410 (such as network interface cards, modems and so forth). The elements may be coupled to each other via system bus 412, which may represent one or more buses. In the case of multiple buses, they may be bridged by one or more bus bridges (not shown).

Each of these elements may perform its conventional functions known in the art. In particular, system memory 404 and mass storage devices 406 may be employed to store a working copy and a permanent copy of the programming instructions implementing the operations associated with content aggregation/distribution servers 104 or content consumption devices 108, earlier described. The various elements may be implemented by assembler instructions supported by processor(s) 402 or high-level languages, such as, for example, C, that can be compiled into such instructions.

The permanent copy of the programming instructions may be placed into permanent storage devices 406 in the factory, or in the field, through, for example, a distribution medium (not shown), such as a compact disc (CD), or through communication interface 410 (from a distribution server (not shown)). That is, one or more distribution media having an implementation of the agent program may be employed to distribute the agent and program various computing devices.

The number, capability and/or capacity of these elements 410-412 may vary, depending on whether computer 400 is used as a content aggregation/distribution server 104 or a content consumption device 108. Their constitutions are otherwise known, and accordingly will not be further described.

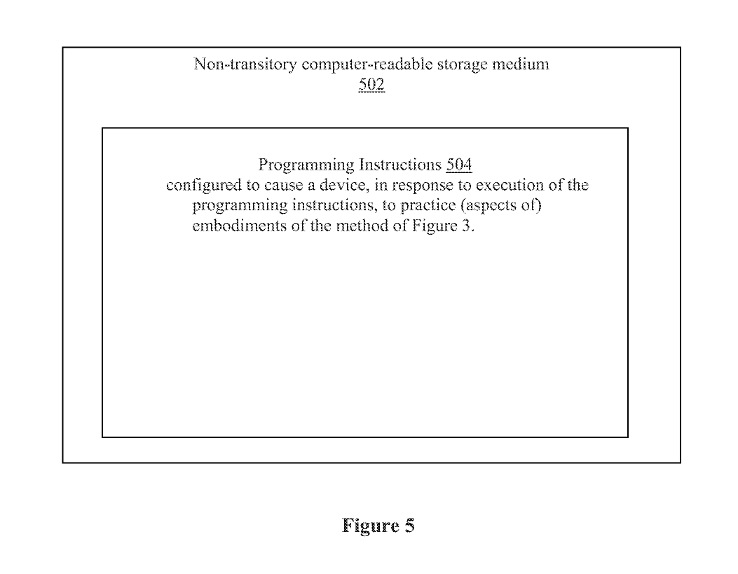

FIG. 5 illustrates an example non-transitory computer-readable storage medium having instructions configured to practice all or selected ones of the operations associated with content aggregation/distribution servers 104 or content consumption devices 108, earlier described; in accordance with various embodiments. As illustrated, non-transitory computer-readable storage medium 502 may include a number of programming instructions 504. Programming instructions 504 may be configured to enable a device, e.g., computer 400, in response to execution of the programming instructions, to perform, e.g., various operations of process 300 of FIG. 3, e.g., but not limited to, to the operations performed to enhance a user's experience while responding to a pause, slow motion, fast forward or rewind command. In alternate embodiments, programming instructions 504 may be disposed on multiple non-transitory computer-readable storage media 502 instead.

Referring back to FIG. 4, for one embodiment, at least one of processors 402 may be packaged together with computational logic 422 configured to practice aspects of the process of FIG. 3. For one embodiment, at least one of processors 402 may be packaged together with computational logic 422 configured to practice aspects of the process of FIG. 3 to form a System in Package (SiP). For one embodiment, at least one of processors 402 may be integrated on the same die with computational logic 422 configured to practice aspects of the process of FIG. 3. For one embodiment, at least one of processors 402 may be packaged together with computational logic 422 configured to practice aspects of the process of FIG. 3 to form a System on Chip (SoC). For at least one embodiment, the SoC may be utilized in, e.g., but not limited to, a computing tablet.

The following paragraphs describe examples of various embodiments. In various embodiments, an apparatus for consuming content may include a decoder configured to receive and decode a streaming of the content. The apparatus may also include a user interface engine configured to receive user commands. The apparatus may also include a presentation engine coupled to the decoder and the user interface engine, and configured to present the content as the content is decoded from the stream, in response to received user commands. In various embodiments, the decoder, the user interface engine, the presentation engine, individually, in combination or sub-combination, may be arranged to adapt the presentation to enhance user experience during response to a first of the user commands, where the adaptation is in addition to a nominal response to the first user command.

In various embodiments, the content may include a plurality of frames and may be available in a plurality of resolutions. The first user command may include a pause command to pause the presentation of the content at one of the frames. The decoder, the user interface engine, the presentation engine, individually, in combination or sub-combination, may be arranged to pause the presentation at the one frame, in response to the pause command, and in addition, retrieve, decode and present a higher resolution version of the paused frame.

In various embodiments, the stream of content may be available in a plurality of resolutions, bit rates or flume rates, and the first user command may include a slow motion command to present the content in slow motion. The decoder, the user interface engine, the presentation engine, individually, in combination or sub-combination, may be arranged to present the content in slow motion in response to the slow motion command, and in addition, switch to decode a higher resolution, bit rate or frame rate version of the stream, and present the content decoded from the higher resolution, bit rate or frame rate version of the stream.

In various embodiments, the stream of content may be available in a plurality of resolutions or bit rates, and the first user command may include a fast forward command to fast forward the content. The decoder, the user interface engine, the presentation engine, individually, in combination or sub-combination, may be arranged to fast forward the content, in response to the fast forward command, and in addition, switch to decode a higher resolution or bit rate version of the stream, and present the content decoded from the higher resolution or bit rate version of the stream.

In various embodiments, the stream of content may be available in a plurality of resolutions or bit rates, and the first user command may include a rewind command to rewind the content. The decoder, the user interface engine, the presentation engine, individually, in combination or sub-combination, may be arranged to rewind the content, in response to the rewind command, and in addition, switch to decode a higher resolution or bit rate version of the stream, and present the content decoded from the higher resolution or bit rate version of the stream.

In various embodiments, the stream of content may be available in a plurality of bit rates, and the first user command may include a fast forward command to fast forward the content. The decoder, the user interface engine, the presentation engine, individually, in combination or sub-combination, may be arranged to fast forward the content, in response to the fast forward command, and in addition, switch to decode a lower bit rate version of the stream, and present the content decoded from the lower bit rate version of the stream.

In various embodiments, the stream of content may be available in a plurality of bit rates, and the first user command may include a rewind command to rewind the content. The user interface engine, the presentation engine, individually, in combination or sub-combination, may be arranged to rewind the content, in response to the rewind command, and in addition, switch to decode a lower bit rate version of the stream, and present the content decoded from the lower bit rate version of the stream.

Computer-readable media (including non-transitory computer-readable media), methods, systems and devices for performing the above-described techniques are illustrative examples of embodiments disclosed herein. Additionally, other devices in the above-described interactions may be configured to perform various disclosed techniques.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

What is claimed is:

1. An apparatus for consuming content, comprising:
a decoder configured to receive and decode a streaming of the content;
a user interface engine configured to receive user commands; and
a presentation engine coupled to the decoder and the user interface engine, and configured to present the content as the content is decoded from the stream, in response to received user commands,
wherein the decoder, the user interface engine, the presentation engine, individually, in combination or sub-combination, are arranged to adapt the presentation to enhance user experience during response to a first of the user commands, where the adaptation is in addition to a nominal response to the first user command.

2. The apparatus of claim 1, wherein the content comprises a plurality of frames and are available in a plurality of resolutions, and the first user command comprises a pause command to pause the presentation of the content at one of the frames; and wherein the decoder, the user interface engine, the presentation engine, individually, in combination or sub-combination, are arranged to pause the presentation at the one frame, in response to the pause command, and in addition, retrieve, decode and present a higher resolution version of the paused frame.

3. The apparatus of claim 1, wherein the stream of content is available in a plurality of resolutions, bit rates or frame rates, and the first user command comprises a slow motion command to present the content in slow motion; and wherein the decoder, the user interface engine, the presentation engine, individually, in combination or sub-combination, are arranged to present the content in slow motion in response to the slow motion command, and in addition, switch to decode a higher resolution, bit rate or frame rate version of the stream, and present the content decoded from the higher resolution, bit rate or frame rate version of the stream.

4. The apparatus of claim 1, wherein the stream of content is available in a plurality of resolutions or bit rates, and the first user command comprises a last forward command to fast forward the content; and wherein the decoder, the user interface engine, the presentation engine, individually, in combination or sub-combination, are arranged to fast forward the content, in response to the fast forward command, and in addition, switch to decode a higher resolution or bit rate version of the stream, and present the content decoded from the higher resolution or bit rate version of the stream.

5. The apparatus of claim 1, wherein the stream of content is available in a plurality of resolutions or bit rates, and the first user command comprises a rewind command to rewind the content; and wherein the decoder, the user interface engine, the presentation engine, individually, in combination or sub-combination, are arranged to rewind the content, in response to the rewind command, and in addition, switch to decode a higher resolution or bit rate version of the stream, and present the content decoded from the higher resolution or bit rate version of the stream.

6. The apparatus of claim 1, wherein the stream of content is available in a plurality of bit rates, and the first user command comprises a fast forward command to fast forward the content; and wherein the decoder, the user interface engine, the presentation engine, individually, in combination or sub-combination, are arranged to fast forward the content, in response to the fast forward command, and in addition, switch to decode a lower bit rate version of the stream, and present the content decoded from the lower bit rate version of the stream.

7. The apparatus of claim 1, wherein the stream of content is available in a plurality of bit rates, and the first user command comprises a rewind command to rewind the content; and wherein the decoder, the user interface engine, the presentation engine, individually, in combination or sub-combination, are arranged to rewind the content, in response to the rewind command, and in addition, switch to decode a tower bit rate version of the stream, and present the content decoded from the lower bit rate version of the stream.

8. A method for consuming content, comprising:
decoding, with a decoder, a streaming of the content;
receiving, with a user interface engine, user commands; and
presenting the content as the content is decoded from the stream, in response to received user commands, including adapting the presentation to enhance user experience during response to at least a first of the user commands, where the adaptation is in addition to a nominal response to the first user command.

9. The method of claim 8, wherein the content comprises a plurality of frames and are available in a plurality of resolutions, and the first user command comprises a pause command to pause the presentation of the content at one of the frames; and wherein in response to receipt of the pause command, presenting comprises pausing the presenting at the one frame, and adapting comprises retrieving, decoding and presenting a her resolution version of the paused frame.

10. The method of claim 8, wherein the stream of content is available in a plurality of resolutions, bit rates or frame rates, and the first user command comprises a slow motion command to present the content in slow motion; and wherein in response to receipt of the slow motion command, presenting comprises presenting the content in slow motion, and adapting comprises switching decoding to a higher resolution, bit rate or frame rate version of the stream, and presenting the content decoded from the higher resolution, bit rate or frame rate version of the stream.

11. The method of claim 8, wherein the stream of content is available in a plurality of resolutions or bit rates, and the first user command comprises a fast forward or a rewind command to respectively fast forward or rewind the content; and wherein in response to receipt of the fast forward or rewind command, presenting respectively comprises fast forward or rewinding the content, and adapting comprises switching to decoding a higher resolution or bit rate version of the stream, and presenting the content decoded from the higher resolution or bit rate version of the stream.

12. The method of claim 8, wherein the stream of content is available in a plurality of bit rates, and the first user command comprises a fast forward or a rewind command to respectively fast forward or rewind the content; and wherein in response to receipt of the fast forward or rewind command, presenting respectively comprises fast forward or rewinding the content, and adapting comprises switching to decoding a lower bit rate version of the stream, and presenting the content decoded from the lower bit rate version of the stream.

13. At least one storage medium comprising a plurality of instructions configured to enable a content consumption device, in response to execution of the instructions, to:
decode a streaming of the content;
receive user commands; and
present the content as the content is decoded from the stream, in response to received user commands, including adaptation of the presentation to enhance user experience during response to a first of the user commands, where the adaptation is in addition to a nominal response to the first user command.

14. The at least one storage medium of claim 13, wherein the content comprises a plurality of frames and are available in a plurality of resolutions, and the first user command comprises a pause command to pause the presentation of the content at one of the frames; and wherein response to receipt of the pause command, present includes pausing the presentation at the one frame, and adaptation that comprises retrieve, decode and present a higher resolution version of the paused frame.

15. The at least one storage medium of claim 13, wherein the stream of content is available in a plurality of resolutions, bit rates or frame rates, and the first user command comprises a slow motion command to present the content in slow motion; and wherein response to the slow motion command includes presentation of the content in slow motion, and adaptation that comprises switch to decode a higher resolution, bit rate or frame rate version of the stream, and present the content decoded from the higher resolution, bit rate or frame rate version of the stream.

16. The at least one storage medium of claim 13, wherein the stream of content is available in a plurality of resolutions or bit rates, and the first user command comprises a fast forward command to fast forward the content; and wherein response to the fast forward command includes fast forward the content, and adaptation that comprises switch to decode a higher resolution or bit rate version of the stream, and present the content decoded from the higher resolution or bit rate version of the stream.

17. The at least one storage medium of claim 13, wherein the stream of content is available in a plurality of resolutions or bit rates, and the first user command comprises a rewind command to rewind the content; and wherein response to the rewind command includes rewind the content, and adaptation that comprises switch to decode a higher resolution or bit rate version of the stream, and present the content decoded from the higher resolution or bit rate version of the stream.

18. The at least one storage medium of claim 13, wherein the stream of content is available in a plurality of bit rates, and the first user command comprises a fast forward command to fast forward the content; and wherein response to the fast forward command includes fast forward the content, and adaptation the comprises switch to decode a lower bit rate version of the stream, and present the content decoded from the tower bit rate version of the stream.

19. The at least one storage medium of claim 13, wherein the stream of content is available in a plurality of bit rates, and the first user command comprises a rewind command to rewind the content; and wherein response to the rewind command includes rewind the content, and adaptation the comprises switch to decode a lower bit rate version of the stream, and present the content decoded from the lower bit rate version of the stream.
